(19) United States
(12) Patent Application Publication
(10) Pub. No.: US 2012/0212412 A1
(43) Pub. Date: Aug. 23, 2012

(54) POINTING DEVICE

(75) Inventors: Yukio Mizuno, Osaka (JP); Yoichi Kuge, Osaka (JP)

(73) Assignee: SHARP KABUSHIKI KAISHA, Osaka (JP)

(21) Appl. No.: 13/504,247

(22) PCT Filed: Jun. 10, 2010
(86) PCT No.: PCT/JP2010/059866

§ 371 Date: Apr. 27, 2012

(30) Foreign Application Priority Data
Oct. 27, 2009 (JP) 2009-246898

(51) Int. Cl. G09G 5/08

(52) U.S. Cl. 345/157

(57) ABSTRACT

Provided is a pointing device that has a simplified configuration and that can be operated in a simple manner. A pointing device according to the present invention has a display device 1 displaying an image and a point indicator device 3 that irradiates the display device 1 with a point indicator light. The display device 1 has a display unit that displays an image using a plurality of pixels, a photodetection unit that detects the point indicator light irradiated onto the display unit to output a detection signal, and a control unit that, based on the detection signal, determines a position at which the point indicator light is irradiated on the display device and determines command content from the point indicator device 3 to the display device 1. The point indicator device 3 has an operation button (command input part) 10 that transmits the command content to the display device 1. The shape of the point indicator light on an illumination surface of the display device 1 changes when the operation button 10 is operated.

### TECHNICAL FIELD

The present invention relates to a pointing device. More specifically, the present invention relates to a pointing device that has a simplified configuration and that can be operated in a simple manner.

### BACKGROUND ART

Conventionally, laser pointers have been used in presentations using large screens. For example, a user giving a presentation directly irradiates an image displayed on a large screen with a laser beam of a laser pointer to indicate a prescribed position on a display screen during the presentation.

However, when a liquid crystal display device is used as the large screen, there has been a problem of difficulty in visually recognizing an irradiation position of the laser pointer irradiated onto the display screen. One of the reasons for this problem is that the reflectance of a deflection plate on the outermost surface is approximately 4%, which is low. In addition, another reason is that the luminance of a pixel displaying white shows brightness of approximately 300 candelas when an image is displayed.

In order to solve this problem, there has been known a pointing device that identifies a pointer position based on an image of a display screen captured using an imaging means and that outputs the identified position to a computer device to display an indicator pointer at the point position (Patent Document 1, for example).

Specifically, as shown in FIG. 18, the conventional pointing device is configured to include a transmission and reception unit 260, a CCD camera 240, which is an imaging device, and a projector 300 (front projection type liquid crystal projector). The projector 300 is configured to include a position detection unit 210 that detects an indicator position based on an imaging signal of the CCD camera 240, an image generation unit 220 that generates an image of a cursor or the like to output to the projector 300 based on a detection result of the indicator position, and an image projection unit 230 that projects a generated image. More specifically, the position detection unit 210 is configured to include a noise filter 211 that removes noise from a captured image, a digitization processing unit 212 that digitizes image information in order to facilitate data processing, a centroid detection unit 213 that detects the centroid of a spotlight based on the digitized image information, and a pointing coordinate detection unit 214 that detects an indicator position (pointor position) based on the detected centroid position. Further, the position detection unit 210 is configured to include a storage unit 216 that stores an acceptable range of the spotlight indicator described above and the like and a determination unit 218 that determines whether the spotlight is within the acceptable indicator range.

Information representing the indicator position detected by the position detection unit 210, information representing whether or not the indicator is within the acceptable range, and the like are outputted from the position detection unit 210 to the image generation unit 220 to be used for generating an image. Further, signals are exchanged between the determination unit 218 and the transmission and reception unit 260. Specifically, the determination unit 218 receives projection state information from a laser pointer (point indicator device) through the transmission and reception unit 260 to transmit control information to the laser pointer. For example, the determination unit 218 detects the irradiation state of light of the laser pointer to determine what command is selected, and if it determines, based on an output from the pointing coordinate detection unit 214, that the pointer is selecting an icon from outside of the image display region, the determination unit 218 transmits a control signal for changing a projection display direction of the spotlight to the laser pointer through the transmission and reception unit 260. Further, the image generation unit 220 generates an image that reflects the indicator position determined by the position detection information from the position detection unit 210 and the command content determined by the determination unit 218. Further, the image projection unit 230 projects light of the image generated by the image generation unit 220 towards the image display region (display device). The presentation image is displayed in the image display region this way.

### RELATED ART DOCUMENTS

### Patent Documents

Patent Document 1: Japanese Patent Application Laid-Open Publication “Japanese Patent Application Laid-Open Publication No. 2002-41238 (Published on Feb. 8, 2002)”

### SUMMARY OF THE INVENTION

### Problems to be Solved by the Invention

However, when an imaging device such as a camera or the like is provided in a pointing device, there is a problem of complicating the configuration of the pointing device. Furthermore, in a technology disclosed in the above-mentioned Patent Document 1, light from the laser pointer (point indicator device) needs to be analyzed on the projector side and sent back to the laser pointer, thereby causing a problem of complicating the device.

Furthermore, in the technology disclosed in the above-mentioned Patent Document 1, in order to switch between a mouse movement, clicking, dragging, and the like, a switch of the laser pointer needs to be changed, causing a problem of complicating the operation.

The present invention seeks to solve the conventional problems described above, and its object is to provide a pointing device that has a simplified configuration and that can be operated in a simple manner.

### Means for Solving the Problems

In order to solve the problems described above, a pointing device according to the present invention has a display device displaying an image and a point indicator device irradiating the display device with a point indicator light. The display device has a display unit that displays an image using a plurality of pixels, a photodetection unit that detects the point indicator light irradiated onto the display unit to output a detection signal, and a control unit that, based on the detection signal, determines a position on the display unit at which the point indicator light is irradiated and determines command content from the point indicator device to the display device. The point indicator device has a command input part that transmits command content to the display device. A shape of the point indicator light on an illumination surface of the display device changes when the command input part is operated.

According to the configuration described above, the shape of the point indicator light on the illumination surface of the display device changes when the command input part is operated. Therefore, the display device can recognize whether or not the command input part is operated based on the point indicator light. Because of this, there is no need to provide an imaging device in the point indicator device, and there is no need to send back the point indicator light analyzed by the display device to the point indicator device. As a result, the device can be simplified.

Furthermore, according to the configuration described above, the shape of the point indicator light on the illumination surface of the display device changes when the command input part is operated. Because of this, there is no need to use a switch or the like in order to switch between a mouse movement, clicking, dragging, and the like. As a result, operation can be performed in a simple manner.

### Effects of the Invention

As described above, a pointing device according to the present invention has a display device displaying an image and a point indicator device irradiating the display device with a point indicator light. The display device has a display unit that displays an image using a plurality of pixels, a photodetection unit that detects the point indicator light irradiated onto the display unit to output a detection signal, and a control unit that, based on the detection signal, determines a position on the display unit at which the point indicator light is irradiated and determines command content from the point indicator device to the display device. The point indicator device has a command input part that transmits command content to the display device. A shape of the point indicator light on an illumination surface of the display device changes when the command input part is operated.

Thus, the pointing device of the present invention has effects of simplifying its configuration and enabling an operation in a simple manner.

### BRIEF DESCRIPTION OF THE DRAWINGS

FIG. 1 is a schematic view showing a configuration of a pointing device according to the present invention.

FIG. 2 is a functional block diagram showing a configuration of a pointing device of the present invention.

FIG. 3 is a functional block diagram showing a configuration of a display device 1 according to the present invention.

FIG. 4 is a circuit block diagram showing a circuit configuration of a liquid crystal panel 32 according to the present invention and a configuration of its peripheral circuit.

FIG. 5 is a pattern diagram showing arrangement states of optical sensors 30 of the liquid crystal panel 32 of the present invention.

FIG. 6 is a timing chart of the display device 1 of the present invention.

FIG. 7 is a schematic view showing a configuration of a conventional pointing device.

FIG. 8 is a schematic view showing a configuration of a pointing device of the present invention.

FIG. 9 is a schematic view showing a configuration of a pointing device of the present invention.

FIG. 10 is a functional block diagram showing a configuration of a control unit 15 according to the present invention.

FIG. 11 is a cross-sectional view showing a configuration of the liquid crystal panel 32 of the present invention.

FIG. 12 is a pattern diagram showing a case in which a photodiode 39b constituting an optical sensor 30b receives a laser beam having a blue wavelength through a color filter 53b in the liquid crystal panel 32 of the present invention.

FIG. 13 is a flow chart showing an example of a processing for detecting a position onto which a laser beam is irradiated in the display device 1 of the present invention.

FIG. 14 is a pattern diagram of scan images when a laser beam is irradiated onto a pixel. FIG. 14(a) shows a scan image when a laser beam is irradiated onto a single pixel. FIG. 14(b) shows a scan image when a laser beam is irradiated onto a plurality of pixels.

FIG. 15 is a pattern diagram showing a case in which a photodiode 39b constituting an optical sensor 30r receives a laser beam having a red wavelength through a color filter 53r in the liquid crystal panel 32 of the present invention.

FIG. 16 is a functional block diagram showing a configuration of the display device 1 of the present invention.

FIG. 17 is a circuit block diagram showing an example of the display device 1 of the present invention when an optical sensor is provided separately from a picture element or a pixel.

FIG. 18 is a functional block diagram showing a configuration of a conventional pointing device.

### DETAILED DESCRIPTION OF EMBODIMENTS

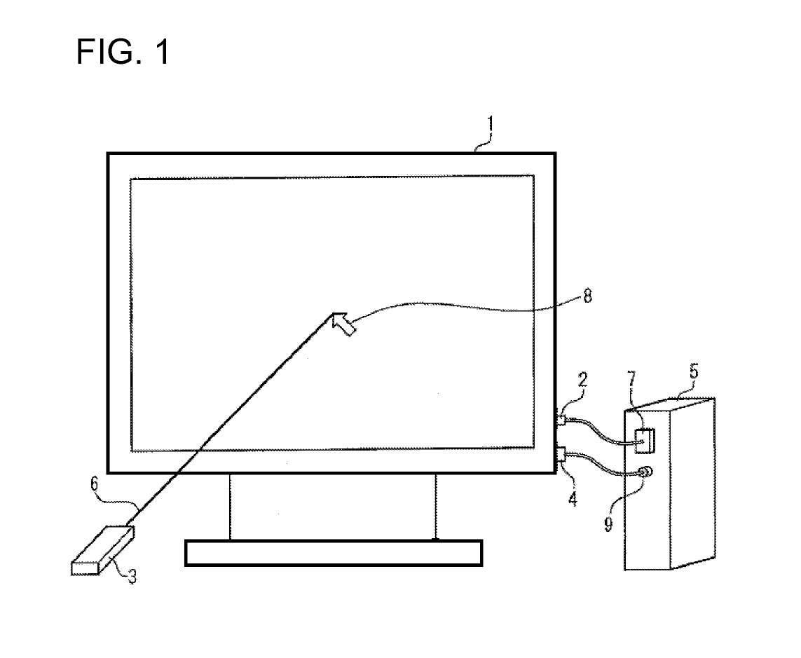

Embodiments of the present invention are described below with reference to FIGS. 1 to 17. Here, the present invention is not limited thereto. Unless there is a particularly restrictive description, dimensions, materials, and shapes of components described in the embodiments as well as their relative arrangement and the like are merely description examples, and the scope of the invention is not limited thereto. Here, in the descriptions below, a case in which the display device used in a pointing device of the present invention is a liquid crystal display device is described as an example.

### Embodiment 1

1-1. Configuration of a Pointing Device

FIG. 1 is a schematic view showing a configuration of a pointing device according to the present invention. A liquid crystal monitor (liquid crystal display device), which is a display device 1, is connected to a computer device, which is an external device 5, through two cables. An input port 2 of the display device 1 is connected to an image output port 7 of the external device 5. An output port 4 of the display device 1 is connected to a pointing device input port 9 of the external device 5.

The external device 5 outputs an image to the display device 1 through the image output port 7. The display device 1 receives the output, and displays the image. When a laser pointer, which is a point indicator device 3, emits a laser beam 6 towards an image display unit of the display device 1, the display device 1 detects the laser beam using a built-in optical sensor, and identifies the coordinates of an image corresponding to the optical sensor that detected the laser beam. Then, position information of the identified coordinates is outputted to the external device 5 through the pointing device input port 9.

Upon receiving the output, the external device 5 recognizes the position of the coordinates, and superimpose a cursor that shows the pointed position on an output image to output it. Upon receiving the output, the display device 1 displays an image including a cursor 8 on the display screen.

As described, in the pointing device of the present invention, a laser beam (point indicator light) is directly irradiated onto the display surface of the display device. This way, a point cursor can be displayed clearly on the display screen.

1-2. Functional Block Diagram of the Pointing Device

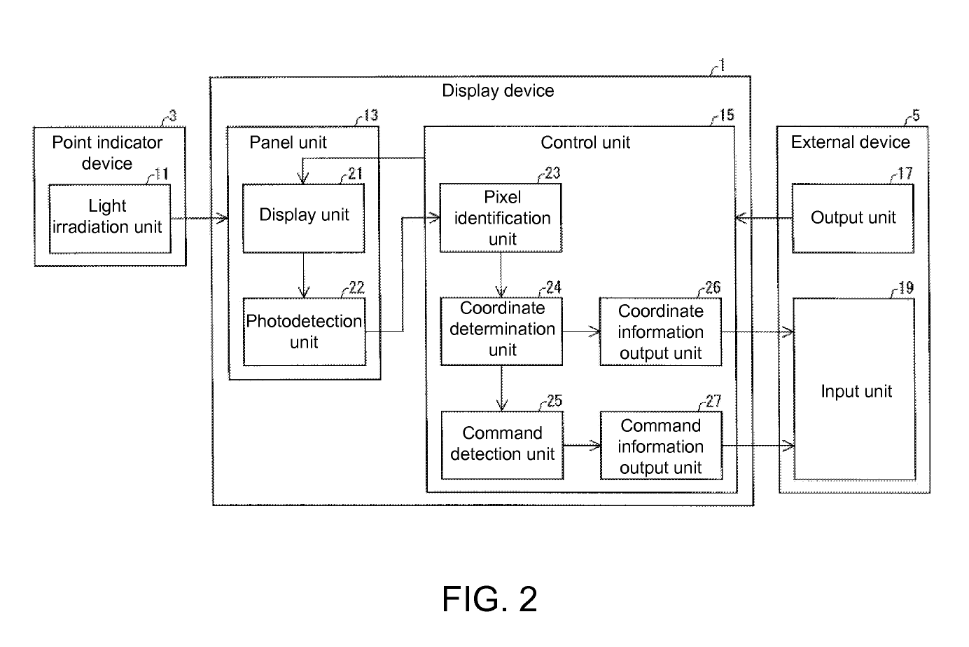

FIG. 2 is a functional block diagram showing a configuration of the pointing device of the present invention. The point indicator device 3 has a light irradiation unit 11 for irradiating a laser beam. The external device 5 has an output unit 17 for outputting image data to the display device 1 and an input unit 19 for receiving an input of coordinate information or command information from the display device 1.

The display device 1 has a panel unit 13 and a control unit 15. A display unit 21 of the panel unit 13 displays an image outputted from the external device 5 using a plurality of pixels. Photodetection units 22 of the panel unit 13 are arranged corresponding to the respective pixels of the display unit 21, and detect a point indicator light irradiated onto any one pixel of the display unit 21 to output a detection signal. Here, the photodetection units 22 of the panel unit 13 may be arranged corresponding to two pixels of the display unit 21.

A pixel identification unit 23 of the control unit 15 identifies a pixel that is at a position onto which a point indicator light is irradiated on the display unit 21 based on a pixel corresponding to the photodetection unit that outputted the detection signal. A coordinate determination unit 24 determines the coordinates inside an image corresponding to the pixel identified by the pixel identification unit 23.

Then, a coordinate information output unit 26 outputs information related to the coordinates determined by the coordinate determination unit 24. A command detection unit 25 detects a command signal (a click command, for example) based on detection of a laser beam having a shape that is different from that of a point indicator light or a shape and a wavelength that are different from those of the point indicator light. When a command signal is detected in the command detection unit, a command information output unit 27 outputs an input of a prescribed command on the coordinates. Here, details of the shape of the laser beam are described later.

As described, in the pointing device of the present invention, information related to an irradiation position of a laser beam irradiated onto the display device 1 from the point indicator device 3 can be outputted to the external device 5 as coordinate information. Furthermore, when a command signal is detected, the detection of a prescribed command signal can be also outputted to the external device 5 as a command signal.

1-3. Functional Block Diagram of the Display Device

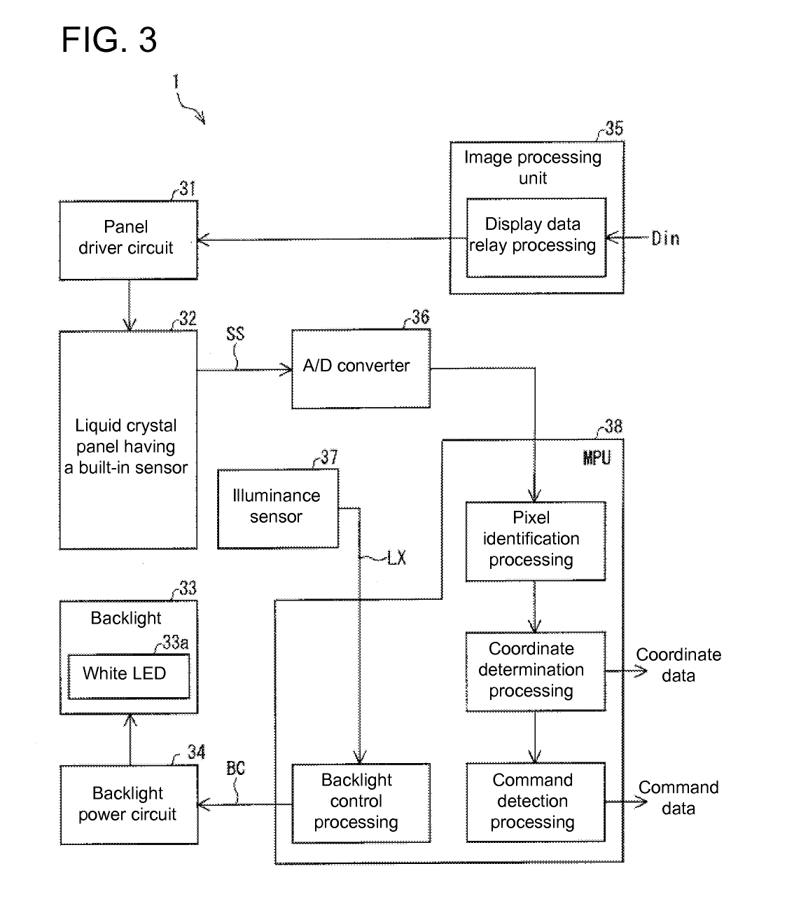

FIG. 3 is a functional block diagram showing a configuration of the display device 1 of the present invention. The display device 1 shown in FIG. 3 has a panel driver circuit 31, a liquid crystal panel having a built-in sensor 32, a backlight 33, a backlight power circuit 34, an A/D converter 36, an image processing unit 35, an illuminance sensor 37, and a microprocessor unit (hereinafter referred to as an MPU) 38.

The liquid crystal panel having a built-in sensor 32 (hereinafter may be referred to as a “liquid crystal panel 32”) includes a plurality of pixel circuits and a plurality of optical sensors that are arranged two-dimensionally. Here, details of the liquid crystal panel 32 are described later.

Display data Din is inputted into the liquid crystal display device 1 from the external device 5. The inputted display data Din is supplied to the panel driver circuit 31 through the image processing unit 35. The panel driver circuit 31 writes a voltage corresponding to the display data Din into a pixel circuit of the liquid crystal panel 32. This way, an image based on the display data Din is displayed on the liquid crystal panel 32 by the respective pixels.

The backlight 33 includes a plurality of white LEDs (Light Emitting Diodes) 33a, and emits light (backlight light) onto a back surface of the liquid crystal panel 32. The backlight power circuit 34 switches between whether or not to supply a power voltage to the backlight 33 according to a backlight control signal BC outputted from the MPU 38. Below, the backlight power circuit 34 supplies a power voltage when the backlight control signal BC is at a high level, and does not supply the power voltage when the backlight control signal BC is at a low level. The backlight 33 lights up when the backlight control signal BC is at a high level. The backlight 33 is turned off when the backlight control signal BC is at a low level.

The liquid crystal panel 32 outputs an output signal of the optical sensor as a sensor output signal SS. The A/D converter 36 converts the analog sensor output signal SS into a digital signal. The output signal of the A/D converter 36 represents a position indicated by a laser beam irradiated from the point indicator device 3. The MPU 38 performs a laser beam position identification processing based on the sensor output signal SS obtained during a sensing period of coordinate information to obtain the position onto which the laser beam is irradiated. Then, the MPU 38 performs a coordinate determination processing based on the results of the position identification processing to determine the coordinates inside the image corresponding to the irradiation position, and outputs the determined coordinates as coordinate data Cout.

Further, the MPU 38 performs the above-mentioned coordinate determination processing and command detection processing based on the sensor output signal SS obtained during a sensing period of command information to determine the coordinates and to detect the command at the coordinate position. Then, the MPU 38 outputs the determined coordinates as coordinate data, and outputs the detected command as command data.

1-4. Circuit Block Diagram of the Display Device

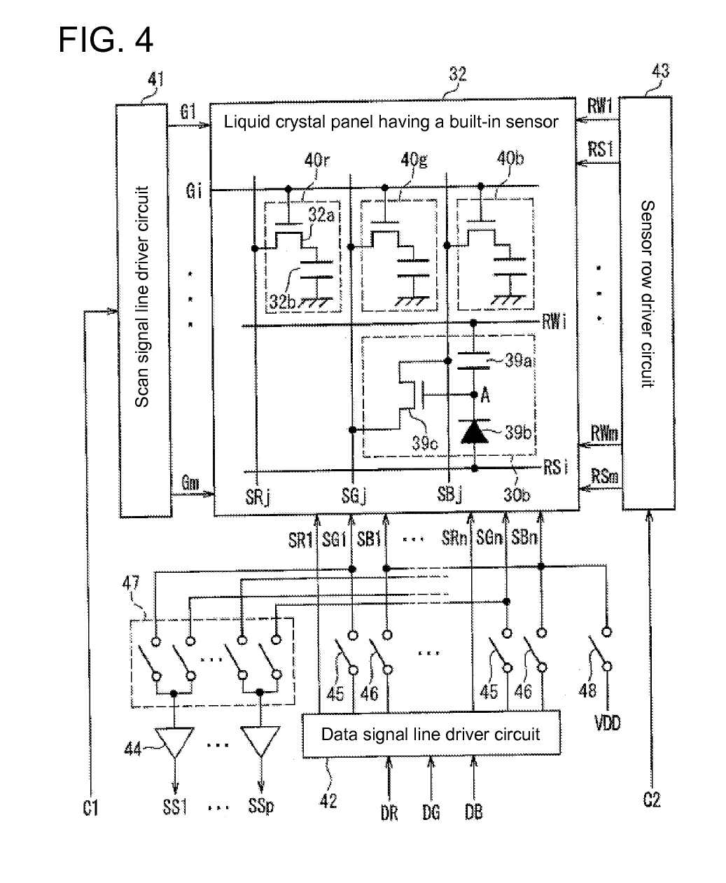

FIG. 4 is a circuit block diagram showing a circuit configuration of the liquid crystal panel 32 of the present invention and a configuration of its peripheral circuit. Here, FIG. 4 is an example in which color filters of RGB are disposed in a stripe arrangement and the optical sensor 30b is disposed such that a photodiode 39b is arranged in the same line as a blue picture element 40b, i.e., such that the photodiode 39b is arranged on the back surface of a blue filter. Here, in order to dispose the color filters, arrangement other than the above-mentioned stripe arrangement, such as a mosaic arrangement, a delta arrangement, or the like, may be used.

In a different pixel that is not shown in FIG. 4, an optical sensor 30r is disposed such that the photodiode 39b is disposed on the back surface of a red filter, which is the same as a red picture element 40. Further, substantially the same number of the optical sensors 30b of the blue picture element 40b and the optical sensors 30r of the red picture element 40r are arranged regularly.

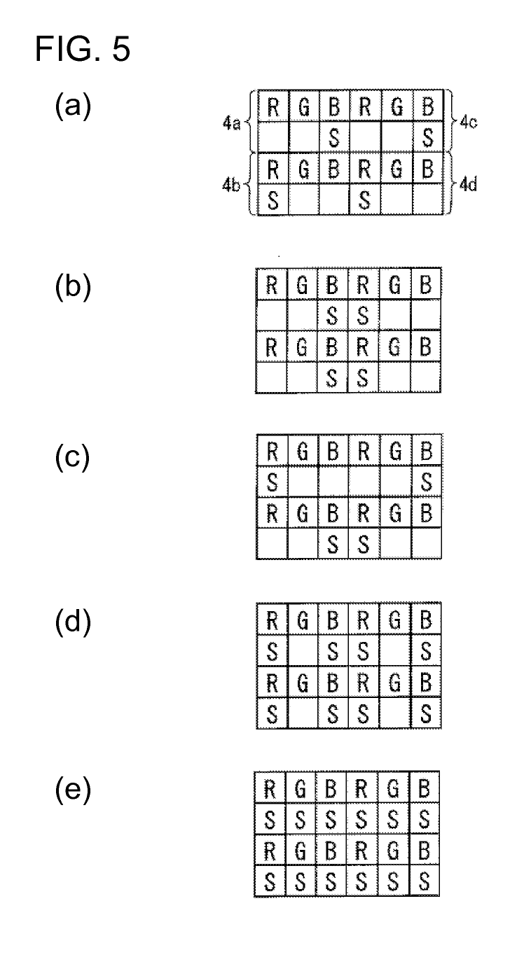

FIG. 5(a) is a pattern diagram showing an example of an arrangement state of the optical sensors 30 in this case. In this figure, “R”, “G”, and “B” represent red picture elements, green picture elements, and blue picture elements, respectively, and “S” represents an optical sensor. In pixels 4a and 4c, the optical sensors “S” are provided in the blue picture elements “B”. In pixels 4b and 4d, the optical sensors “S” are provided in the red picture elements 4b.

Here, in FIG. 5(a), the optical sensors “S” are provided in different picture elements in the respective horizontal lines. However, the arrangement rule is not limited thereto. As shown in FIG. 5(b), the optical sensors “S” may be provided in different picture elements in the respective vertical lines, for example. Alternatively, as shown in FIG. 5(c), the optical sensors “S” may be disposed in different picture elements in the respective pixels that are adjacent to each other. Alternatively, as shown in FIG. 5(d) or FIG. 5(e), the optical sensor “S” may be provided in every picture element.

Below, an example in which the optical sensor 30b, which is disposed such that its photodiode 39b is arranged on the back surface of the blue filter in the same line as the blue picture element 40b, outputs a sensor output signal is described.

As shown in FIG. 4, the liquid crystal panel 32 has an m number of scan signal lines G1 to Gm, a 3n number of data signal lines SR1 to SRn, SG1 to SGn, and SB1 to SBn, and an (m×3n) number of pixel circuits 40 (40r, 40g, and 40b). The liquid crystal panel 32 also has an (×n) number of optical sensors 30, an m number of sensor read-out lines RW1 to RWm, and an m number of sensor reset lines RS1 to RSm.

The scan signal lines G1 to Gm are arranged parallel to each other. The data signal lines SR1 to SRn, SG1 to SGn, and SB1 to SBn are arranged parallel to each other so as to be orthogonal to the scan signal lines G1 to Gm. The sensor read-out lines RW1 to RWm and the sensor reset lines RS1 to RSm are arranged parallel to the scan signal lines G1 to Gm.

The pixel circuits 40 (40r, 40g, and 40b) are provided respectively in the proximity of intersections of the scan signal lines G1 to Gm and the data signal lines SR1 to SRn, SG1 to SGn, and SB1 to SBn. An m number of pixel circuits 40 are arranged in a column direction (vertical direction in FIG. 4), and a 3n number of pixel circuits 40 are arranged as a set in a row direction (horizontal direction in FIG. 4). They are arranged two-dimensionally as a whole.

The pixel circuits 40 are divided into a red (R) pixel circuit 40r, a green (G) pixel circuit 40g, and a blue (B) pixel circuit 40b depending on the color of the color filters provided. The three types of pixel circuits 40r, 40g, and 40b (hereinafter referred to as a picture element (subpixel), respectively) are disposed to be aligned in the row direction. The three types of pixel circuits constitute a single pixel.

The pixel circuits 40 include TFTs (Thin Film Transistors) 32a and liquid crystal capacitances 32b. Gate terminals of the TFTs 32a are connected to the scan signal line Gi (i is an integer that is equal to 1 or more and that is equal to m or less), and source terminals are connected to any one of the data signal lines SRj, SGj, and SBj (j is an integer that is equal to 1 or more and that is equal to n or less). Drain terminals are connected to one of the electrodes of the liquid crystal capacitances 32b. A common electrode voltage is applied to the other one of the electrodes of the liquid crystal capacitances 32b. Below, the data signal lines SG1 to SGn that are connected to the green (G) pixel circuit 40g are referred to as G data signal lines. The data signal lines SB1 to SBn that are connected to the blue (B) pixel circuit 40b are referred to as B data signal lines. Here, the pixel circuits 40 may include an auxiliary capacitance.

The transmittance of light (luminance of a picture element) of the pixel circuits 40 is determined by a voltage written into the pixel circuits 40. In order to write a voltage into the pixel circuit 40 connected to the scan signal line Gi and a data signal line SXj (X is either R, G, or B), a high level voltage (voltage that turns on the TFTs 32a) is applied to the scan signal line Gi, and a voltage to be written into the pixel circuit 40 is applied to the data signal line SXj. By writing a voltage corresponding to the display data Din into the pixel circuit 40, the luminance of the picture element can be set at a desired level.

The optical sensor 30 includes a capacitor 39a, a photodiode 39b, and a sensor preamplifier 39c, and is provided for at least each blue picture element 40b (blue (B) pixel circuit 40b).

One electrode of the capacitor 39a is connected to a cathode terminal of the photodiode 39b (this connection point is hereinafter referred to as a “node point A”). The other electrode of the capacitor 39a is connected to the sensor read-out line RWi, and an anode terminal of the photodiode 39b is connected to the sensor reset line RSi. The sensor preamplifier 39c is constituted of a TFT in which a gate terminal is connected to the node point A; a drain terminal is connected to the B data signal line SBj; and a source terminal is connected to the G data signal line SGj.

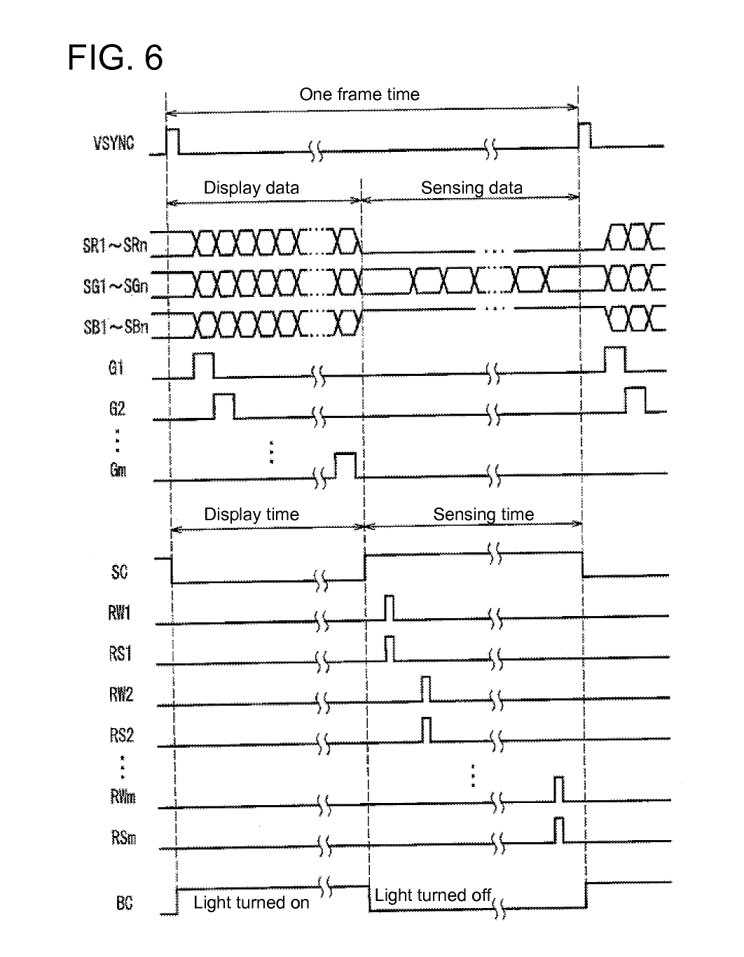

In order to detect the amount of light using the optical sensor 30 connected to the sensor read-out line RWi, the B data signal line SBj, and the like, a prescribed voltage can be applied to the sensor read-out line RWi and the sensor reset line RSi at timing of the timing chart shown in FIG. 6 to apply a power voltage VDD to the B data signal line SBj. When light enters the photodiode 39b after the prescribed voltage is applied to the sensor read-out line RWi and the sensor reset line RSi, a current corresponding to the amount of light entered flows into the photodiode 39b, and the voltage of the node point A decreases by the amount of the current flowed. When the power voltage VDD is applied to the B data signal line SBj, the voltage of the node point A is amplified by the sensor preamplifier 39c, and an amplified voltage is outputted to the G data signal line SGj. Thus, the amount of light detected by the optical sensor 30 can be obtained based on the voltage of the G data signal line SGj.

Around the liquid crystal panel 32, a scan signal line driver circuit 41, a data signal line driver circuit 42, a sensor row driver circuit 43, a p number (p is an integer that is equal to 1 or more and that is equal to n or less) of sensor output amplifiers 44, and a plurality of switches 45 to 48 are provided. The scan signal line driver circuit 41, the data signal line driver circuit 42, and the sensor row driver circuit 43 correspond to the panel driver circuit 31 in FIG. 3.

The data signal line driver circuit 42 has a 3n number of output terminals corresponding to the 3n number of data signal lines. Between the G data signal lines SG1 to SGn and the corresponding n number of output terminals, switches 45 are provided one by one, respectively. Between the B data signal lines SB1 to SBn and the corresponding n number of output terminals, switches 46 are provided one by one, respectively. The G data signal lines SG1 to SGn are divided into groups of a p number, and between the kth (k is an integer that is equal to 1 or more and that is equal to p or less) G data signal lines of the groups and an input terminal of the kth sensor output amplifier 44, switches 47 are provided one by one, respectively. The B data signal lines SB1 to SBn are all connected to one end of a switch 48, and the power voltage VDD is applied to the other end of the switch 48. The number of the switches 45 to 47 included in FIG. 4 is n, and the number of the switch 48 is one.

The circuit shown in FIG. 4 performs different operations during a display period and a sensing period. During the display period, the switches 45 and 46 are turned on, and the switches 47 and 48 are turned off. On the other hand, during the sensing period, the switches 45 and 46 are turned off, and the switch 48 is turned on. The switches 47 become turned on by time division so that the respective groups of the G data signal lines SG1 to SGn are connected to the input terminal of the sensor output amplifier 44 successively.

During the display period shown in FIG. 6, the scan signal line driver circuit 41 and the data signal line driver circuit 42 operate. The scan signal line driver circuit 41 selects one scan signal line from the scan signal lines G1 to Gm per one line time according to a timing control signal C1. The scan signal line driver circuit 41 applies a high level voltage to the selected scan signal line, and applies a low level voltage to the remaining scan signal lines. The data signal line driver circuit 42 drives the data signal lines SR1 to SRn, SG1 to SGn, and SB1 to SBn in a line sequential manner based on display data DR, DG, and DB outputted from the image processing unit 35. More specifically, the data signal line driver circuit 42 stores the display data DR, DG, and DB for at least one row at a time, respectively, and applies voltages corresponding to the display data for one row to the data signal lines SR1 to SRn, SG1 to SGn, and SB1 to SBn for every single line time. Here, the data signal line driver circuit 42 may drive the data signal lines SR1 to SRn, SG1 to SGn, and SB1 to SBn in a dot sequential manner.

During the sensing period shown in FIG. 6, the sensor row driver circuit 43 and the sensor output amplifier 44 operate. The sensor row driver circuit 43 selects one signal line in every single line time from the sensor read-out lines RW1 to RWm and from the sensor reset lines RS1 to RSm, respectively, based on a timing control signal C2. The sensor row driver circuit 43 applies a prescribed read-out voltage and a prescribed reset voltage to the selected sensor read-out line and sensor reset line, respectively, and applies voltages that are different from those voltages for the selected signal line to the remaining signal lines. Here, typically, the duration of the single line time is different in this sensing period from that in the display period. The sensor output amplifier 44 amplifies a voltage selected by the switches 47, and outputs it as sensor output signals SS1 to SSp.

Here, in FIG. 6, the backlight control signal BC is at a high level during the display period, and is at a low level during the sensing period. In this case, the backlight 33 lights up during the display period, and does not light up during the sensing period. Because of this, effects of light from the backlight on the photodiode 39b can be reduced.

1-5. Functional Block Diagram of a Display Device using a Point Indicator Device of the Present Invention

In the pointing device of the present invention, the point indicator device 3 has an operation button (command input part) 10 that transmits the command content to the display device 1. The shape of a laser beam on an illumination surface of the display device 1 changes when the operation button 10 is operated. Further, in the pointing device of the present invention, the operation button 10 preferably is operated by pressing down the operation button 10, and the shape of the laser beam on the illumination surface of the display device 1 preferably becomes larger when the operation button 10 is pressed down compared to when the operation button 10 is not pressed down. Further, in the pointing device of the present invention, transmission of the command content from the point indicator device 3 to the display device 1 preferably is performed only in a direction from the point indicator device 3 towards the display device 1.

Here, the point indicator device 3 has an ON/OFF switch that outputs a laser beam and the operation button 10, which corresponds to a mouse button.

A pointing device using the point indicator device of the present invention is described in comparison to a pointing device using a conventional point indicator device.

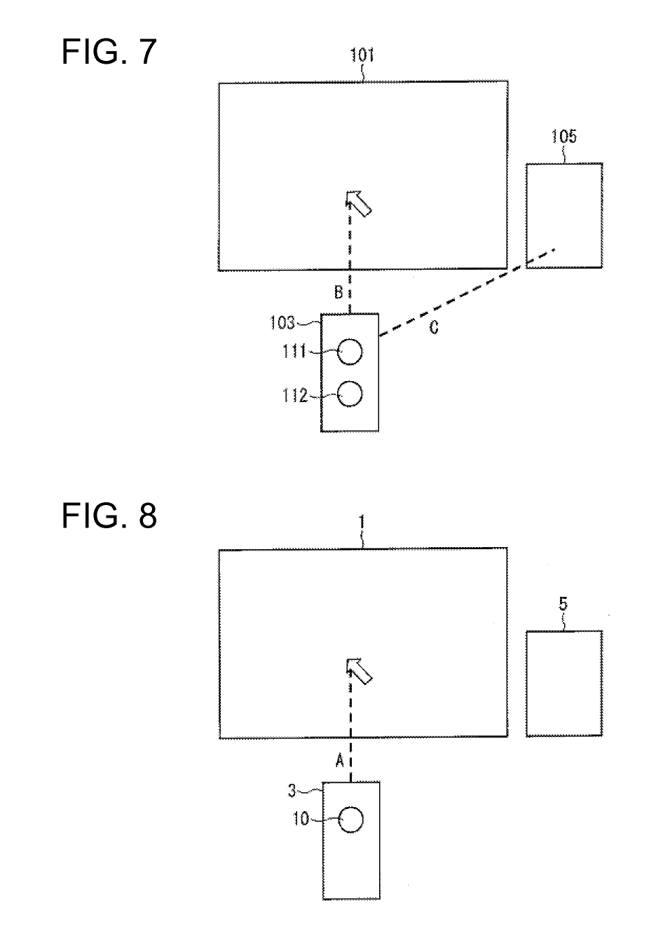

FIG. 7 is a schematic view showing a configuration of the conventional pointing device. In the conventional pointing device, in order to differentiate between an movement operation and a click operation of a mouse when transmitting command content from a point indicator device 103 to a display device 101, an operation mode was switched by a switch on the output side of the point indicator device 103 to emit a laser beam having a different wavelength, a laser beam having a different shape, and the like. Specifically, as shown in FIG. 7, when transmitting command content from the point indicator device 103 to the display device 101, the operation mode was switched by the switch on the output side of the point indicator device 103 in order to differentiate between the movement operation and the click operation of the mouse. For the movement operation of the mouse, pointing was performed, and a laser beam was directed in the direction of the display device 101 (direction B in FIG. 7). On the other hand, for the click operation, operation was performed using an operation button 111 for sending a page and an operation button 112 for returning the page to direct a laser beam in the direction of an external device 105 (direction C in FIG. 7), for example.

On the other hand, FIG. 8 is a schematic view showing a configuration of the pointing device of the present invention. In the pointing device of the present invention, when transmitting command content from the point indicator device 3 to the display device 1, the operation button (command input part) 10 is operated to emit laser beams having different shapes in order to differentiate between the movement operation and the click operation of the mouse. Specifically, as shown in FIG. 8, when transmitting the command content from the point indicator device 3 to the display device 1, in order to differentiate between the movement operation and the click operation of the mouse, the shape of the laser beam on the illumination surface of the display device 1 is changed by operating (pressing down or the like) the operation button 10 in the point indicator device 3 to emit the laser beam in the direction of the display device 1 (direction A in FIG. 8).

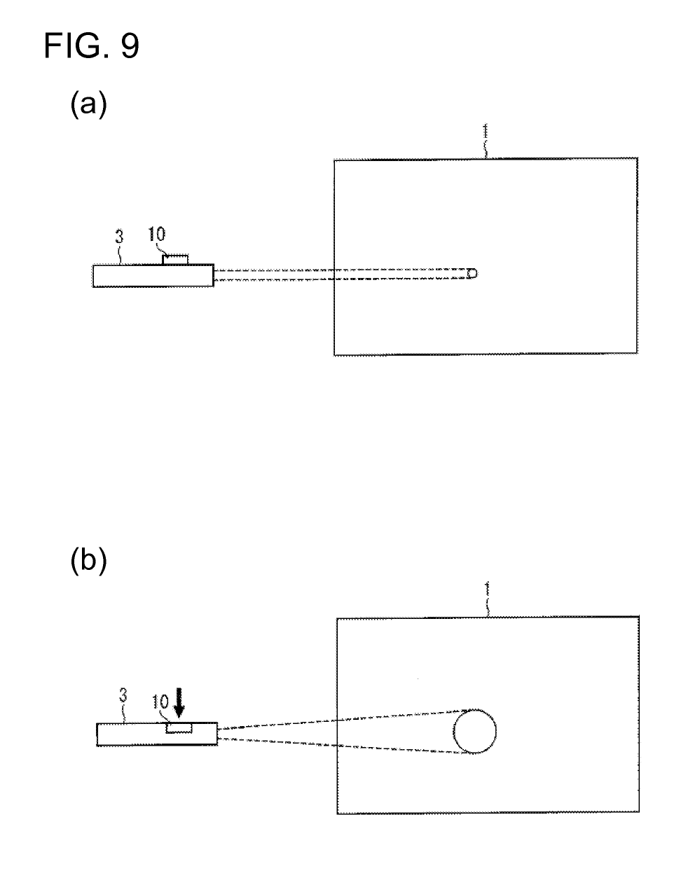

Changing of the shape of the laser beam on the illumination surface of the display device 1 by operating (pressing down or the like) the operation button 10 in the point indicator device 3 is described in detail using FIG. 9(a) and FIG. 9(b).

FIG. 9(a) and FIG. 9(b) are schematic views showing a configuration of the pointing device of the present invention. Here, in FIG. 9(a) and FIG. 9(b), pressing down of the operation button 10 is described as an example of an operation of the operation button 10. FIG. 9(a) shows the point indicator device 3 and the display device 1 before the operation button 10 is pressed down. FIG. 9(b) shows the point indicator device 3 and the display device 1 after the operation button 10 is pressed down.

As shown in FIG. 9(a), before the operation button 10 is pressed down (normal pointing operation), the shape of the laser beam on the illumination surface of the display device 1 is small. On the other hand, as shown in FIG. 9(b), after the operation button 10 is pressed down, the shape of the laser beam on the illumination surface of the display device 1 becomes larger.

Inside the display device 1, the panel unit 13 obtains the state (position and shape) of the above-mentioned laser beam, and sends the obtained values to the control unit 15. Then, the control unit 15 recognizes the position (obtain coordinates) and the shape using the values above.

This way, in the display device 1, the control unit 15 recognizes a “cursor movement operation (pointing operation)” when the shape of the laser beam on the illumination surface of the display device 1 is small. On the other hand, the control unit 15 recognizes a “cursor movement operation (pointing operation) and an operation button pressing down operation” when the shape of the laser beam on the illumination surface of the display device 1 is large.

In the display device 1, when the shape of the laser beam on the illumination surface of the display device 1 goes “from small to small”, for example, the “cursor movement operation (pointing operation)” is recognized. When the shape goes “from small to large”, the “cursor movement operation (pointing operation) and a button down operation” are recognized. When the shape goes “from large to large”, the “cursor movement operation (pointing operation) and a drag operation” are recognized. When the shape goes “from large to small”, the “cursor movement operation (pointing operation) and a button up operation” are recognized.

As a result, a user can perform a click operation and a drag operation by pointing and pressing down the operation button in the same manner as a conventional mouse operation without switching the operation mode.

Further, in the pointing of the present invention, the control unit 15 in the display device 1 preferably digitizes a portion onto which the laser beam is irradiated and a portion onto which the laser beam is not irradiated in the display device 1.

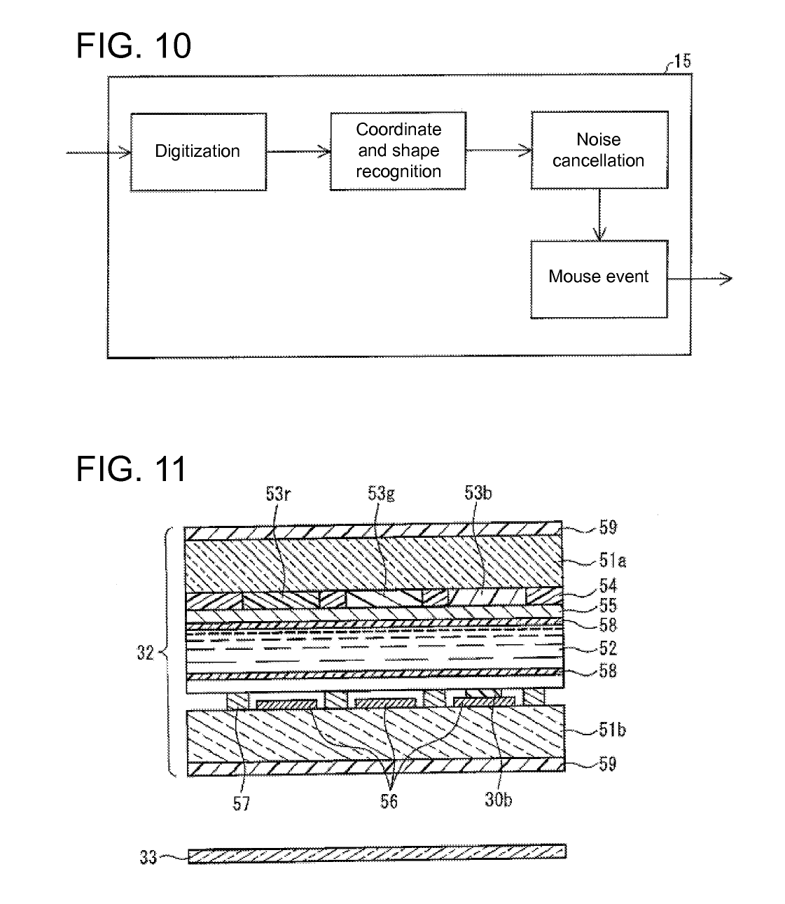

FIG. 10 is a functional block diagram showing a configuration of the control unit 15 (portion corresponding to a PC) of the present invention. Here, the control unit 15 may be realized on the MPU 38 side shown in FIG. 3. As shown in FIG. 10, the control unit 15 performs digitization, recognition of coordinates and shapes, noise cancellation, and a mouse event based on information inputted from the panel unit 13.

Here, digitization means differentiating between a portion onto which a laser beam is irradiated and a portion onto which the laser beam is not irradiated. Recognition of coordinates and shapes means calculating coordinates of the laser beam from digitization data and calculating the shape of the laser beam. Noise cancellation means correcting a slight shift in coordinates. The mouse event means issuing an event of moving a cursor of the mouse when the shape of the laser beam is small and issuing an event of pressing down the mouse button when the shape of the laser beam is large depending on the shape of the laser beam.

Here, in embodiments of the present invention, a case in which the shape of the laser beam becomes larger when the operation button 10 is pressed down is described. However, the present invention is not limited thereto, and a case in which the shape of the laser beam becomes smaller when the operation button 10 is pressed down and the like are also included in the present invention.

1-6. Cross-Sectional View of the Liquid Crystal Panel

FIG. 11 is a cross-sectional view showing a configuration of the liquid crystal panel 32 of the present invention. The liquid crystal panel 32 has a configuration in which a liquid crystal layer 52 is disposed between two glass substrates 51a and 51b. One glass substrate 51a has color filters of three colors 53r, 53g, and 53b, a light shielding film 54, an opposite electrode 55, and the like. The other glass substrate 51b has pixel electrodes 56, data signal lines 57, the optical sensor 30, and the like.

The optical sensor 30 is provided in the proximity of the pixel electrode 56 having the blue color filter 53b, for example. In this case, at least the photodiode 39b of the optical sensor 30 preferably is disposed on the back surface of the center of the color filters 53 in order to receive light transmitted through the color filters 53 in a secure manner.

On the surfaces of the glass substrates 51a and 51b facing each other, alignment films 58 are disposed, and polarizing plates 59 are disposed on the other surfaces. Of the two surfaces of the liquid crystal panel 32, the surface on the glass substrate 51a side becomes the front surface, and the surface on the glass substrate 51b side becomes the back surface. The backlight 33 is disposed on the back surface side of the liquid crystal panel 32.

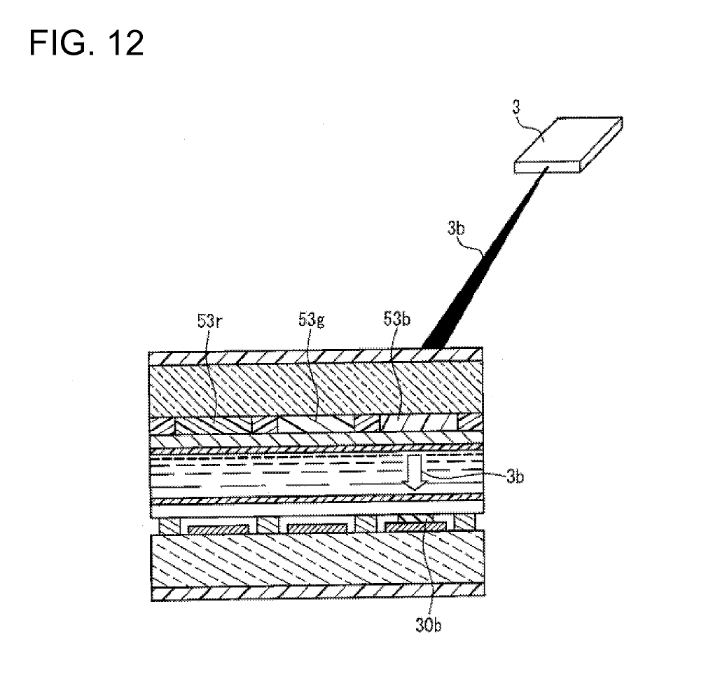

FIG. 12 is a pattern diagram of the photodiode 39b constituting the optical sensor 30b of the liquid crystal panel 32 when it receives a laser beam having a blue wavelength irradiated from the point indicator device 3 through the color filter 53b. The photodiode 39b constituting the optical sensor 30b is formed on the back surface (lower side in FIG. 12) of the blue color filter 53b. Therefore, it can only receive light 3b having a blue wavelength. This is because light other than the light of a blue wavelength is blocked by the color filter 53b.

As a result, the light 3b of a blue wavelength reaches and is received only by the photodiode 39b constituting the optical sensor 30b, and is not received by the photodiode 39b constituting the optical sensor 30r. Thus, the color filters 53 function as a wavelength filter of the optical sensor 30.

In the present embodiment, the position of an image irradiated by a laser beam is detected using the light 3b of a blue wavelength.

1-7. Pixel Identification Processing

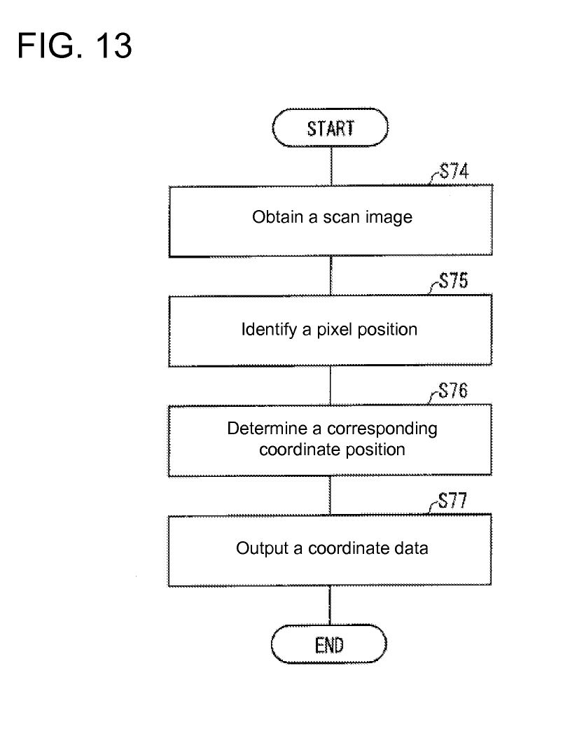

FIG. 13 is a flow chart showing an example of a processing to identify a position onto which a laser beam is irradiated in the display device 1 of the present invention. The processing shown in FIG. 13 is performed by the MPU 38 shown in FIG. 3 during one frame time.

The A/D converter 36 (see FIG. 3) converts an analog output signal SS outputted from the built-in optical sensor 30 in the liquid crystal panel 32 into a digital signal. For example, when performing position detection using a blue laser beam irradiated from the laser beam, the output signal SS from the optical sensor 30 disposed corresponding to blue picture elements is converted into a digital signal.

The MPU 38 obtains this digital signal as a scan image (step S74). In addition, the MPU 38 performs a processing to identify the position of the pixel with respect to the obtained scan image (step S75).

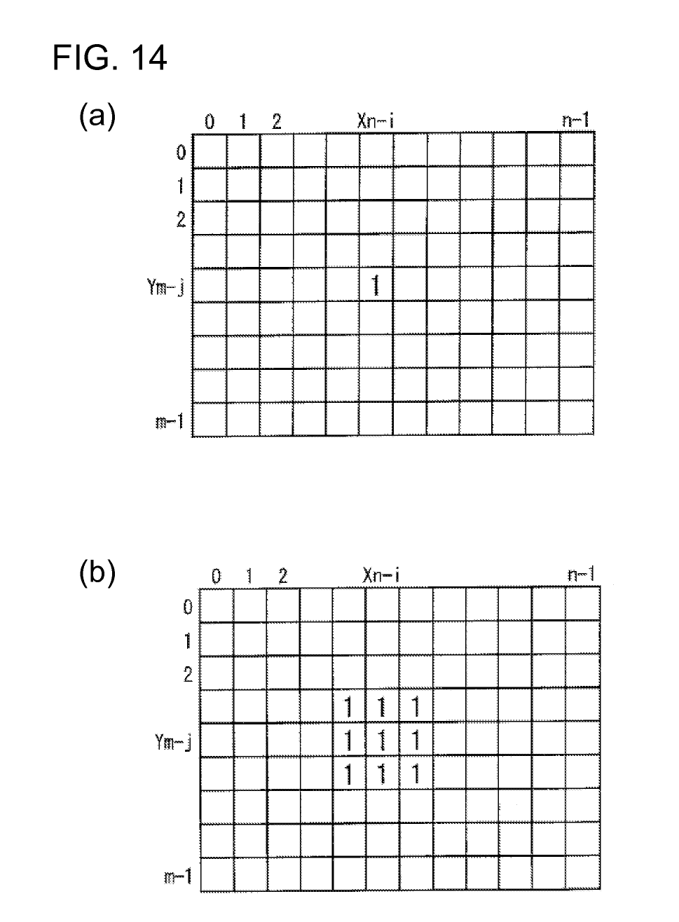

FIG. 14(a) is a pattern diagram of a scan image in which the number of pixels is m×n, for example. As shown in FIG. 14(a), when the scan image is digitalized based on a prescribed threshold, the pixel having the value “1” is determined to be a pixel onto which the laser beam is irradiated, and the pixel position of this pixel is identified. In FIG. 14(a), the pixel position (Xn-i, Ym-j) is identified.

On the other hand, FIG. 14(b) shows a scan image when a laser beam is irradiated onto a plurality of pixels because the irradiation range of the laser beam is large. In this case, the identified pixel position includes eight pixels surrounding the pixel position (Xn-i, Ym-j). Here, the scan image of FIG. 14(b) is obtained when the arrangement rule shown in either FIG. 5(d) or FIG. 5(e) is applied.

When the pixel position is identified, the MPU 38 performs a processing to determine a position of coordinates inside an image corresponding to the identified pixel (step S76). As shown in FIG. 14(a), for example, coordinates corresponding to the identified pixel position (Xn-i, Ym-j) are determined. When the image resolution of the display image and the screen resolution of the liquid crystal panel correspond to each other at “m×n”, the pixel position (Xn-i, Ym-j) is determined as the coordinate position. Here, when the image resolution and the screen resolution do not correspond to each other, the position of the coordinates corresponding to the pixel position can be determined by performing coordinate transformation.

Here, as shown in FIG. 14(b), when positions of eight pixels including the pixel position (Xn-i, Ym-j) are identified, the coordinate position can be determined in accordance with a prescribed rule. The coordinate position can be determined based on the pixel closest to the centroid of the identified pixels, for example. In this case, as shown in FIG. 14(b), the corresponding coordinates can be determined based on the pixel position (Xn-i, Ym-j), which corresponds to the centroid of the plurality of pixels having the value “1.” Alternatively, in FIG. 14(b), coordinates corresponding to positions of all of the pixels having the value “1” may be determined as coordinate positions.

When the coordinate position is determined, the MPU 38 outputs coordinate data Cout at the determined coordinates to the external device 5 (computer device) (step S77). The external device 5 recognizes a point position based on coordinate data outputted from the display device 1, and outputs the cursor 8 (see FIG. 1) by superimposing it on an output image.

When the coordinate data Cout is at one point, for example, the cursor 8 is displayed such that the tip of the arrow shaped cursor 8 (same as a conventional mouse cursor) is at the coordinate position.

This way, the cursor 8 is displayed accurately at a position irradiated by a laser beam (blue laser beam, for example) on the liquid crystal panel 32 of the display device 1. The processing above is performed during one frame time. Because of this, when an operator operating the laser pointer moves the irradiation position of the laser beam, the position of the cursor 8 also moves.

Here, when the coordinate data Cout have a plurality of points, the shape of the cursor may be formed by all of the coordinates shown by the coordinate data Cout. In this case, the irradiation range of the laser beam matches the cursor shape, and it can be visibly recognized as if the liquid crystal panel 32 were irradiated by the laser beam.

1-8. Command Detection Processing

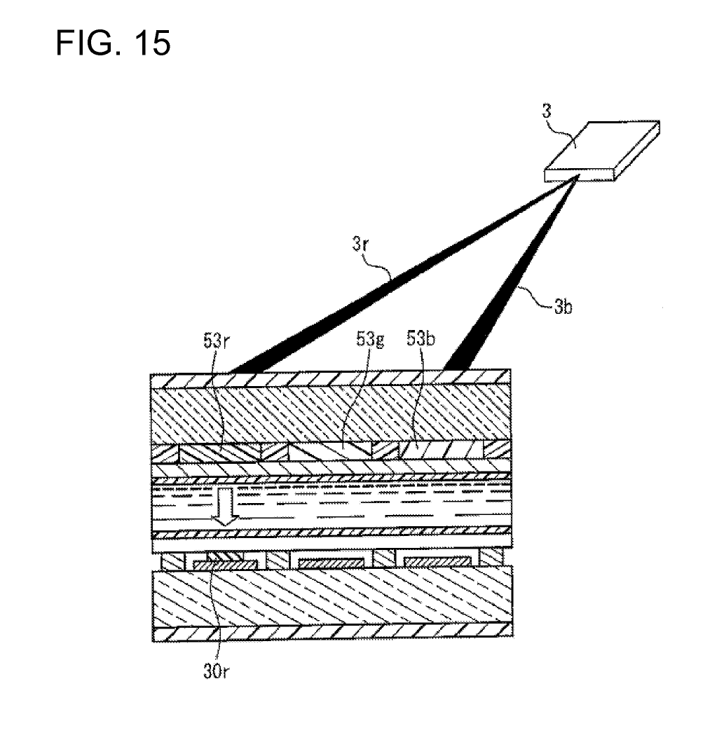

FIG. 15 is a pattern diagram showing a case in which the photodiode 39b constituting the optical sensor 30r of the liquid crystal panel 32 receives a laser beam having a red wavelength irradiated by the point indicator device 3 through the color filter 53r. In the present embodiment, a click command with respect to an image irradiated by a laser beam is detected using light 3r having a red wavelength.

The photodiode 39b constituting the optical sensor 30r is formed on the back surface of the red color filter 53r. Because of this, it can receive only the light 3r having a red wavelength. This is because light having a wavelength other than the red wavelength is blocked by the color filter 53r as described above.

Thus, the light 3r of the red wavelength reaches and is received only by the photodiode 39b of the optical sensor 30r disposed on the back surface of the red picture element 40r. The light 3r is not received by the photodiode 39b of the optical sensor 30b disposed on the back surface of the blue picture element 40b.

In the display device 1, a processing to detect a position onto which a laser beam having a red wavelength (red wavelength pixel identification processing) is irradiated is performed by the MPU 38 in one frame time in the same manner as a processing to detect a position onto which a laser beam having a blue wavelength (blue wavelength pixel identification processing) is irradiated, as shown in FIG. 13. The red wavelength pixel identification processing is performed in one frame time that is different from a frame time during which the blue wavelength pixel identification processing is performed, for example. Alternatively, the blue wavelength pixel identification processing and the red wavelength pixel identification processing may be performed during the same single frame time, respectively.

Then, when detecting a command using the red laser beam 3r, the A/D converter 36 converts the output signal SS from the optical sensor disposed corresponding to the red picture element into a digital signal.

The MPU 38 obtains this digital signal as a scan image (step S74). Then, the MPU 38 performs a processing to identify a pixel position with respect to the obtained scan image (step S75). When the pixel position is identified, the MPU 38 performs a processing to determine a coordinate position within an image corresponding to the identified pixel (step S76).

When the coordinate position is determined, the MPU 38 outputs command data (a click command, for example) to be generated when a laser beam having a red wavelength is detected to the external device 5 (computer device) in addition to the coordinate data at the determined coordinates (step S77). The external device 5 recognizes a command position to perform a prescribed command processing (click processing, for example) based on the coordinate data outputted from the display device 1.

1-9. Summary

As described above, according to the present embodiment, when the display surface of the display device 1 is directly irradiated with laser beams having different shapes using the point indicator device 3, a point cursor can be clearly displayed on the display screen, and a command processing (click processing, for example) can be performed in a secure manner at a display position of the point cursor. In addition, the point cursor can be displayed clearly on the display screen when the display surface of the display device 1 is directly irradiated with a laser beam having a blue wavelength using the point indicator device 3. Furthermore, a command processing (click processing, for example) may be performed in a secure manner at the display position of the point cursor when a laser beam having a red wavelength is directly emitted.

Thus, a user can perform a pointer operation and a click operation using either a pointing device having a simple configuration that simply irradiates laser beams having two types of shapes or a pointing device having a simple configuration that simply irradiates laser beams having two types of shapes and two colors. Further, according to the present embodiment, convenience of the user performing the point operation can be improved by using the pointing device having a simple configuration. Furthermore, according to the present embodiment, the optical sensors are disposed corresponding to pixels. This way, the accuracy of identifying a pointer position can be determined based on the arrangement accuracy.

Modified Example of Embodiment 1

2-1. Regarding Device Configuration

In the above-mentioned embodiments, an example in which the pointing device is constituted of the display device 1 and the external device 5 was described. However, the present invention can be applied in a case in which the display device 1 and the external device 5 are integrated. A personal computer device having an integrated monitor, a notebook computer device, a television device that is operated using a screen, and the like correspond to this, for example.

Further, the above-mentioned embodiments show an example in which a computer device is used as the external device 5. However, when a television device is used as the display device, the external device 5 may be a recording and playback device using an optical disk, a hard disk, or the like.

Furthermore, when a television device having a two-way communication function is used as the display device, the present invention may be applied for an input operation. This way, an input operation can be performed with respect to the television device remotely in a non-contact manner using a laser pointer.

2-2. Regarding Commands

In the above-mentioned embodiments, a command based on irradiation of a laser beam having a large shape and a command based on irradiation of a laser beam having a red wavelength were described in association with a click command. However, other commands may be used. They may be associated with a right click command, a double click command, a drag command, or the like, for example.

2-3. Regarding Laser Beam

In the above-mentioned embodiments, a laser beam having a blue wavelength was used for detecting coordinate information, and a laser beam having a red wavelength was used for detecting command information. However, a laser beam having a wavelength of another color may be used as long as it is a laser beam that can be received by the photodiode 39b of the optical sensor 30 through the color filters 53. A laser beam having a red wavelength or a green wavelength may be used for detecting coordinate information, and a laser beam having a blue wavelength or a green wavelength may be used for detecting command information, for example.

Here, the laser beam to be used may be either a continuous wave or a pulse wave.

2-4. Regarding Optical Sensors

The above-mentioned embodiments show a configuration in which the optical sensors are disposed corresponding to the blue picture elements and the red picture elements, respectively. However, optical sensors may be disposed corresponding to the green picture elements in addition. Thus, as shown in FIG. 5(e), the optical sensors may be disposed in all of the picture elements. In this case, the optical sensors corresponding to the green picture elements may be used as sensors for detecting the environmental illuminance. By changing the threshold of the A/D converter 36 based on a detected environmental illuminance, whether or not light having a prescribed wavelength is irradiated onto the liquid crystal panel 32 can be determined accurately, for example.

### Embodiment 2

The above-mentioned embodiments described an example in which the photodiode 39b constituting the optical sensor corresponding to a pixel that displays the cursor 8 detects a click command or the like at a display position of the cursor 8 based on a received laser beam having a large shape and a red wavelength. However, detection of the click command and the like may not necessarily have to be performed using the optical sensor corresponding to the pixel.

This embodiment describes an example in which a command signal receiver disposed in the display device 1 detects a click command or the like at a display position of the cursor 8 based on reception of a command signal by an electromagnetic wave sent from a command signal transmitter in the point indicator device 3.

3-1. Functional Block Diagram of the Display Device

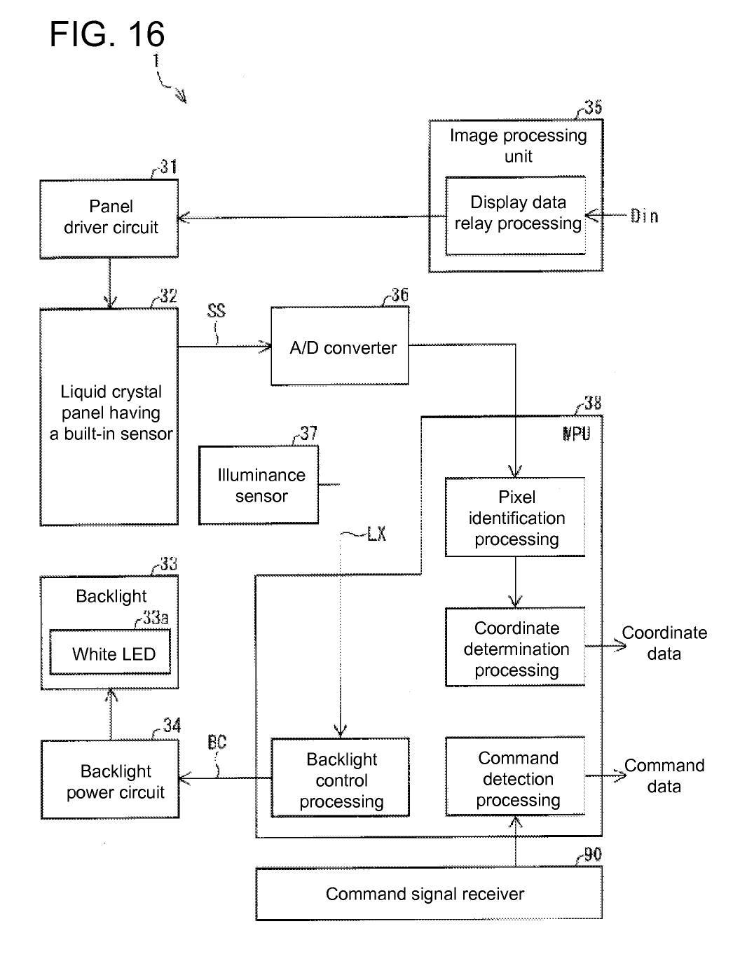

FIG. 16 is a functional block diagram showing a configuration of the display device 1 according to the present embodiment. The display device 1 shown in FIG. 16 has a command signal receiver 90 in addition to the display device 1 shown in FIG. 3. Further, the point indicator device 3 according to the present embodiment has a command signal transmitter (not shown in the figure).

When a laser pointer, which is the point indicator device 3, irradiates the display device 1 with a laser beam 6, the cursor 8 is displayed on the display device 1 (see FIG. 1). When a click operation by pressing down a button or the like is performed in the point indicator device 3 while the cursor 8 is displayed, the point indicator device 3 sends an electromagnetic signal that is different from an electromagnetic signal before the click operation towards the display device 1.

The command signal receiver 90 of the display device 1 receives a prescribed electromagnetic signal sent from the point indicator device 3 through a signal reception unit (not shown in the figure), and notifies the MPU 38 that a command signal has been received. Upon receiving this notification, the MPU 38 outputs command data (click command, for example) generated at a coordinate position of the cursor 8 to the external device 5.

As described above, in the present embodiment, the coordinate information is detected based on an output from the optical sensor 30 that received a laser beam, and a command information is detected based on an output from the command signal receiver 90 that received an electromagnetic signal.

Here, as the electromagnetic signal sent from the point indicator device 3 to the display device 1, a radio wave signal or an ultrasonic signal may be used. Furthermore, when detecting a command using the electromagnetic signal, the wavelength of the laser beam irradiated for point indication is not limited to a blue wavelength.

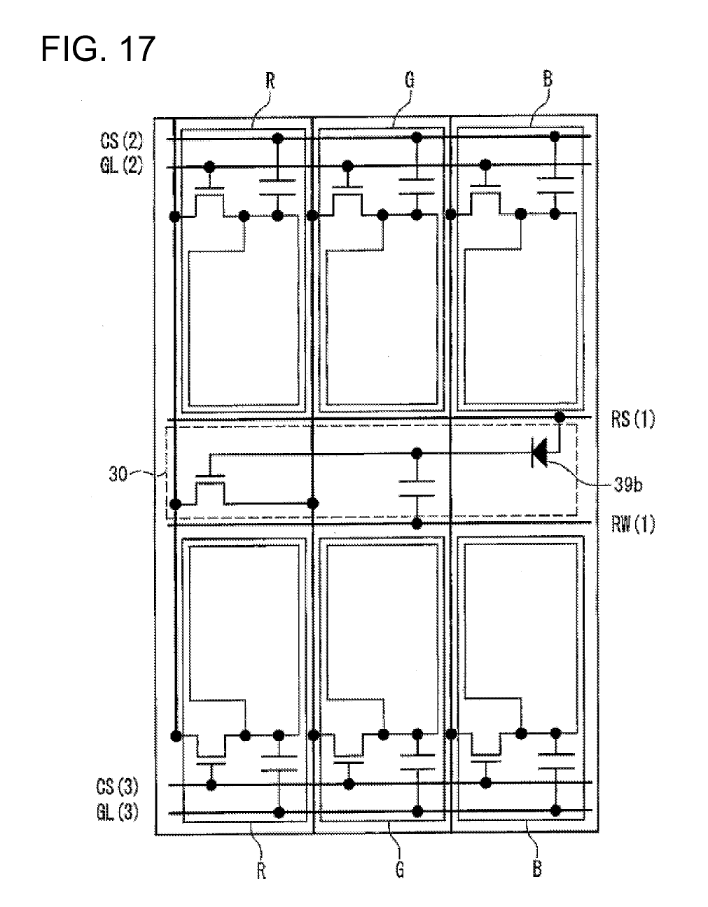

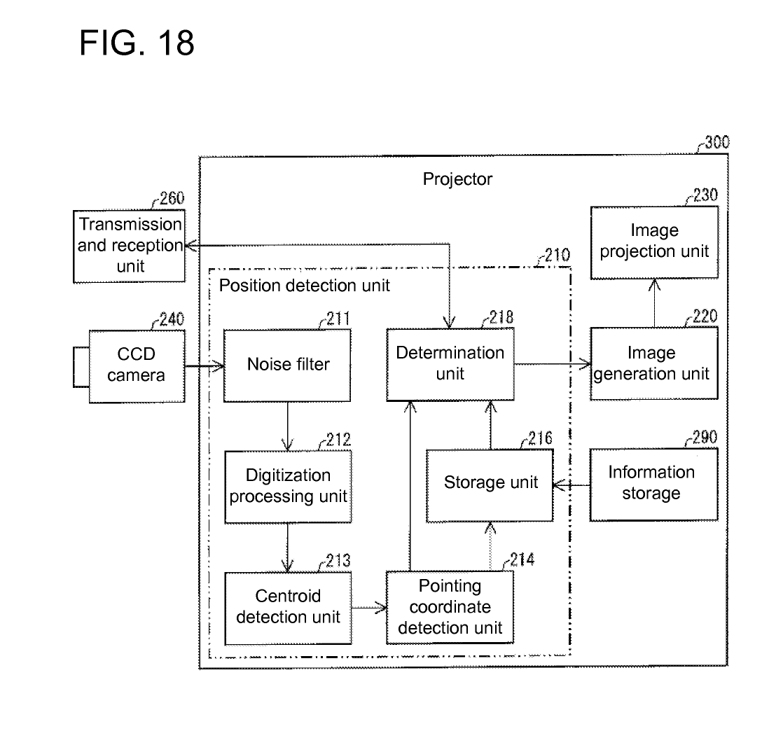

In addition, there is no need to receive the laser beam from the point indicator device 3 through the color filters 53. As shown in FIG. 17, for example, color filters R, color filters G, and color filters B are respectively disposed on front surfaces of the respective picture elements constituting a single pixel, and color filters are not disposed on the front surface of the photodiode 39b constituting the optical sensor 30. This way, the photodiode 39b can receive laser beams of all wavelengths.

In this case, the detection ability of the optical sensor 30 improves, and even a laser beam having a weak output can be detected. Here, as the laser beam, a laser beam having any wavelength, such as white light, red light, blue light, or green light, may be used.

### Preferable Example of the Present Invention

In the pointing device of the present invention, an operation of the command input part preferably is pressing down the command input part. When the command input part is pressed down, the shape of the point indicator light on an illumination surface of the display device preferably becomes larger compared to when the command input part is not pressed down.

Because of this, the pointing device of the present invention can recognize whether or not an operation is performed in the command input part more effectively.

Further, in the pointing device of the present invention, the control unit in the display device preferably digitizes a portion onto which the point indicator light is irradiated and a portion onto which the point indicator light is not irradiated in the display device.

This way, in the pointing device of the present invention, it becomes easier to recognize whether or not an operation is performed in the command input part.

Further, in the pointing device of the present invention, transmission of command content from the point indicator device to the display device preferably is performed only in a direction from the point indicator device towards the display device.

This way, the pointing device of the present invention can be simplified further.

Furthermore, in the pointing device of the present invention, the wavelength of the point indicator light irradiated onto the display device preferably changes when the command input part is operated. In addition, in the pointing device of the present invention, the electromagnetic wave of the point indicator light irradiated onto the display device preferably changes when the command input part is operated.

This way, the pointing device of the present invention can recognize whether or not an operation is performed in the command input part in a more secure manner.

Further, in the pointing device of the present invention, the display device preferably is a liquid crystal display device.

This way, the pointing device of the present invention can have advantages of the liquid crystal display device.

### Other Embodiments

The present invention is not limited to the respective embodiments described above, and various modifications within a scope shown in the claims are possible. Embodiments obtained by appropriately combining technical means respectively disclosed in different embodiments are also included in the technical scope of the present invention.

Thus, the specific embodiments and examples described above merely clarify technical content of the present invention. The present invention should not be limited to these specific examples, and should not be interpreted narrowly. The present invention can be modified and implemented in various ways within the spirit of the present invention and the scope of claims set forth below.

### INDUSTRIAL APPLICABILITY

The present invention can be applied in a pointing device that is provided with a display device having a photodetection unit and the like.

### DESCRIPTION OF REFERENCE CHARACTERS

1 display device

3 point indicator device

5 external device

10 operation button (command input part)

30 optical sensor

31 panel driver circuit

32 liquid crystal panel having a built-in sensor

33 backlight

33a white LEDs

34 backlight power circuit

35 image processing unit

36 A/D converter

37 illuminance sensor

38 microprocessor unit (MPU)

41 scan signal line driver circuit

42 data signal line driver circuit

43 sensor row driver circuit

44 sensor output amplifier

45 to 48 switches

53 color filters

1. A pointing device, comprising a display device displaying an image; and a point indicator device irradiating said display device with a point indicator light,
wherein said display device has a display unit that displays an image using a plurality of pixels, a photodetection unit that detects the point indicator light irradiated onto said display unit to output a detection signal, and a control unit that, based on said detection signal, determines a position on said display unit at which said point indicator light is irradiated and determines command content sent from said point indicator device to said display device,
wherein said point indicator device has a command input part that transmits command content to said display device, and
wherein a shape of said point indicator light on an illumination surface of said display device changes when said command input part is operated.

2. The pointing device according to claim 1,
wherein said operation of said command input part is pressing down of said command input part, and
wherein when said command input part is pressed down, the shape of said point indicator light on the illumination surface of said display device becomes larger compared to when said command input part is not pressed down.

3. The pointing device according to claim 1, wherein said control unit in said display device digitizes a portion onto which said point indicator light is irradiated and a portion onto which said point indicator light is not irradiated in said display device.

4. The pointing device according to claim 1, wherein command content from said point indicator device to said display device is transmitted only in a direction from said point indicator device to said display device.

5. Further, the pointing device according to claim 1, wherein a wavelength of said point indicator light irradiated onto said display device changes when said command input part is operated.

6. Further, the pointing device according to claim 1, wherein an electromagnetic wave of said point indicator light irradiated onto said display device is sent to the display device from the point indicator device when said command input part is operated.

7. The pointing device according to claim 1, wherein said display device is a liquid crystal display device.
